(19) United States
(12) Patent Application Publication
(10) Pub. No.: US 2025/0174729 A1
(43) Pub. Date: May 29, 2025

(54) LITHIUM-ION BATTERY

(71) Applicant: TOYOTA JIDOSHA KABUSHIKI KAISHA, Aichi-ken (JP)

(72) Inventor: Aiko NAGANO, Nisshin-shi (JP)

(21) Appl. No.: 18/963,521

(22) Filed: Nov. 28, 2024

(30) Foreign Application Priority Data
Nov. 29, 2023 (JP) 2023-201630

(51) Int. Cl. H01M 10/0585; H01M 10/0525

(52) U.S. Cl. CPC H01M 10/0585; H01M 10/0525

(57) ABSTRACT

A lithium-ion battery comprises a power generation element and an electrolyte solution. The power generation element includes a positive electrode, a separator, a negative electrode, a first interposed layer, and a second interposed layer. A first gap is a gap formed between the negative electrode active material layer and the separator. A second gap is a gap formed between the positive electrode active material layer and the separator. The first interposed layer is placed at at least one of the first gap and the second gap. The second interposed layer is placed at at least one of the first gap and the second gap. A relationship of “P1≠P2” is satisfied. P1 represents a coefficient of permeability of the electrolyte solution through the first interposed layer. P2 represents a coefficient of permeability of the electrolyte solution through the second interposed layer.

### CROSS REFERENCE TO RELATED APPLICATIONS

This nonprovisional application is based on Japanese Patent Application No. 2023-201630 filed on Nov. 29, 2023, with the Japan Patent Office, the entire contents of which are hereby incorporated by reference.

### BACKGROUND OF THE DISCLOSURE

### Field of the Disclosure

The present disclosure relates to a lithium-ion battery.

### Description of the Background Art

Japanese Patent Laying-Open No. 2018-106981 discloses a belt-shaped electrode sheet of a wound electrode assembly wherein a region with a small coefficient of permeability of electrolyte solution is provided at an end portion (in the width direction) of an active material layer.

### SUMMARY OF THE DISCLOSURE

A lithium-ion battery comprises a power generation element. The power generation element is also called “an electrode assembly”, “an electrode group”, and the like, for example. The power generation element includes a positive electrode active material layer, a separator, and a negative electrode active material layer. Each of the active material layers is a porous body having pores, and electrolyte solution is retained in these pores.

During high-rate charging, active material may rapidly expand. Due to the expansion of the active material, pores in the active material layer may decrease. Due to the decrease of pores, the electrolyte solution may flow out of the active material layer. Due to the flowing-out of the electrolyte solution, the active material layer may become short of electrolyte solution. Due to the shortage of electrolyte solution in the active material layer, battery performance may be degraded.

On the other hand, during discharging, the active material may shrink. Due to the shrinkage of the active material, pores in the active material layer increase. Due to the increase of pores, the electrolyte solution present near the active material layer may flow into the active material layer. Because the amount of the electrolyte solution flowing out during charging is different from the amount of the electrolyte solution flowing into during discharging, the salt concentration of the electrolyte solution may become different between inside and outside of the active material layer. As charging and discharging are repeated, the difference in the salt concentration between inside and outside of the active material layer may be increased, potentially causing degradation of battery performance. Desirably, battery performance tends not to be degraded during high-rate charging and discharging; in other words, there is a demand for improvement in “high-rate resistance”.

A coefficient of permeability indicates how readily electrolyte solution permeates. The greater the coefficient of permeability is, the more readily the electrolyte solution is considered to permeate through the target. When a region with a small coefficient of permeability is provided at an edge portion of the active material layer in a wound-type power generation element, flowing-out of electrolyte solution from the active material layer is expected to be reduced. For example, when the composition, density, and/or the like of the active material layer varies depending on the position, the coefficient of permeability may also vary depending on the position. However, when the composition and/or the like of the active material layer varies depending on the position, inconveniences such as an increase of variations in performance may occur. In addition, when the composition and/or the like of the active material layer varies depending on the position, productivity may be degraded. Furthermore, because electrolyte solution that flew out from the active material layer tends not to flow back into the active material layer, the difference in the salt concentration between inside and outside of the active material layer can be increased.

An object of the present disclosure is to improve high-rate resistance.

Hereinafter, the technical configuration and effects of the present disclosure will be described. It should be noted that the action mechanism includes presumption. The action mechanism does not limit the technical scope of the present disclosure.

1. A lithium-ion battery comprises a power generation element and an electrolyte solution. The power generation element includes a positive electrode, a separator, a negative electrode, a first interposed layer, and a second interposed layer. The positive electrode and the negative electrode are alternately stacked with the separator interposed therebetween. The positive electrode includes a positive electrode current-collecting foil and a positive electrode active material layer. The negative electrode includes a negative electrode current-collecting foil and a negative electrode active material layer.

At least one of a first gap and a second gap is formed in the power generation element. The first gap is a gap formed between the negative electrode active material layer and the separator. The second gap is a gap formed between the positive electrode active material layer and the separator. The first interposed layer is placed at at least one of the first gap and the second gap. The second interposed layer is placed at at least one of the first gap and the second gap.

The power generation element has a stacking direction. The stacking direction is parallel to a thickness direction of the positive electrode, the separator, and the negative electrode. The power generation element has a first end portion at one end in the stacking direction and also has a second end portion at the other end in the stacking direction. The first interposed layer is closer to the first end portion than the second interposed layer is.

A relationship of an expression (1) below is satisfied.

P1≠P2 (1)

In the expression (1), P1 represents a coefficient of permeability of the electrolyte solution through the first interposed layer. P2 represents a coefficient of permeability of the electrolyte solution through the second interposed layer.

The “interposed layer” is interposed between the active material layer and the separator. When the material of the interposed layer has a higher melting point than the material of the separator, the interposed layer may also be called “an HRL (Heat Resistance Layer)” and the like. According to new findings, a substantial amount of electrolyte solution flows in and out of the power generation element not only through the active material layer but also through the interposed layer. Conventionally, a power generation element includes one type of interposed layer.

In the present disclosure, the power generation element includes a first interposed layer and a second interposed layer. The coefficient of permeability through the first interposed layer is different from that through the second interposed layer. In other words, permeability of electrolyte solution through the first interposed layer is different from the same through the second interposed layer. According to further new findings, in a stack-type power generation element, when two types of interposed layers different in permeability of electrolyte solution are placed at proper positions, high-rate resistance is expected to be improved. More specifically, the power generation element has a first end portion at one end in the stacking direction and also has a second end portion at the other end in the stacking direction. The first interposed layer is closer to the first end portion than the second interposed layer is. The interposed layer with a smaller liquid permeability is capable of retaining electrolyte solution. With the electrolyte solution retained in the interposed layer, shortage of electrolyte solution is expected to be relieved. On the other hand, the interposed layer with a greater liquid permeability is capable of facilitating flowing-out and flowing-in of electrolyte solution. With the flowing-out and flowing-in of electrolyte solution near the interposed layer becoming active, electrolyte solution is expected to become more often mixed between inside and outside of the power generation element. Due to the mixing of the electrolyte solution, the difference in the salt concentration is expected to be reduced. It is conceivable that these actions synergistically improve high-rate resistance.

2. The lithium-ion battery according to “1” above may include the following configuration, for example. The electrolyte solution is distributed more at the first end portion than at the second end portion.

Due to the action of gravity, in the power generation element, the electrolyte solution tends to be abundant at the lower side in the vertical direction. On the other hand, at the upper side in the vertical direction, due to flowing-out of the electrolyte solution, shortage of the electrolyte solution tends to occur. This is because the electrolyte solution that flew out tends not to fully return up to the original height. For example, the first interposed layer may be placed at a position in the stacking direction where abundance of the electrolyte solution tends to occur. For example, the second interposed layer may be placed at a position in the stacking direction where shortage of the electrolyte solution tends to occur. The stacking direction may or may not be parallel to the vertical direction.

3. The lithium-ion battery according to “1” or “2” above may include the following configuration, for example. The first interposed layer is placed at the second gap. The second interposed layer is placed at the first gap.

For example, the first interposed layer may be placed between the positive electrode active material layer and the separator. For example, the second interposed layer may be placed between the negative electrode active material layer and the separator.

4. The lithium-ion battery according to any one of “1” to “3” above may include the following configuration, for example. A relationship of an expression (2) below is satisfied.

P1>P2 (2)

For example, the coefficient of permeability through the first interposed layer, (P1), may be greater than the coefficient of permeability through the second interposed layer, (P2).

5. The lithium-ion battery according to any one of “1” to “4” above may include the following configuration, for example. The electrolyte solution includes a supporting salt and a solvent. The first interposed layer includes first inorganic particles and a first binder. The second interposed layer includes second inorganic particles and a second binder. A relationship of an expression (3) below is satisfied.

Δ1>Δ2 (3)

In the expression (3), Δ1 represents an absolute value of a difference between an SP value of the electrolyte solution and an SP value of the first binder. Δ2 represents an absolute value of a difference between an SP value of the electrolyte solution and an SP value of the second binder. A unit of the SP value is (cal/cm³)^{1/2}.

For example, permeability of the electrolyte solution may be adjusted by changing the SP value (solubility parameter). The greater the absolute value of the difference between the SP value of the solvent in the electrolyte solution and the SP value of the binder in the interposed layer is, the more actively the electrolyte solution tends to flow in and flow out through the interposed layer. Hereinafter, “the absolute value of the difference” may also be simply called “the difference”.

6. The lithium-ion battery according to “5” above may include the following configuration, for example. Relationships of an expression (4) and an expression (5) below are satisfied.

2.5≤Δ1 (4)

Δ2≤2 (5)

When Δ1 is 2.5 or more, flowing-out and flowing-in of the electrolyte solution through the interposed layer is expected to be facilitated. When Δ2 is 2 or less, the electrolyte solution is expected to be more likely retained in the interposed layer.

7. The lithium-ion battery according to “2” above may include the following configuration, for example. The power generation element includes a first unit and a second unit. In the stacking direction, the first unit is closer to the first end portion than the second unit is. Each of the first unit and the second unit includes the positive electrode, the separator, and the negative electrode. The first unit includes the first interposed layer at at least one of the first gap and the second gap. The second unit includes the second interposed layer at at least one of the first gap and the second gap. A relationship of an expression (2) below is satisfied.

P1>P2 (2)

The power generation element may include a plurality of types of units (repeating units). The first unit is placed at a position in the stacking direction where abundance of the electrolyte solution tends to occur. The first unit includes the first interposed layer. The coefficient of permeability through the first interposed layer, (P1), is relatively great. With the flowing-out and flowing-in of the electrolyte solution through the first interposed layer of the first unit becoming active, the electrolyte solution is expected to become more often mixed between inside and outside of the power generation element. Due to the mixing of the electrolyte solution, the difference in the salt concentration is expected to be reduced. On the other hand, the second unit is placed at a position in the stacking direction where shortage of the electrolyte solution tends to occur. The second unit includes the second interposed layer. The coefficient of permeability through the second interposed layer, (P2), is relatively small. With the electrolyte solution retained in the second interposed layer, flowing-out of the electrolyte solution from the second unit may be reduced. These actions are expected to synergistically improve high-rate resistance.

8. The lithium-ion battery according to “7” above may include the following configuration, for example. The second unit includes the second interposed layer at the second gap.

In the second unit, when the second interposed layer is placed between the negative electrode active material layer and the separator, flowing-out of the electrolyte solution is expected to be reduced.

In the following, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view of an example of a lithium-ion battery according to the present embodiment.

FIG. 2 is a conceptual view illustrating a first example of a first unit.

FIG. 3 is a conceptual view illustrating a second example of the first unit.

FIG. 4 is a conceptual view illustrating a third example of the first unit.

FIG. 5 is a conceptual view illustrating a fourth example of the first unit.

FIG. 6 is a conceptual view illustrating a fifth example of the first unit.

FIG. 7 is a conceptual view illustrating a sixth example of the first unit.

FIG. 8 is a conceptual view illustrating a seventh example of the first unit.

FIG. 9 is a conceptual view illustrating a first example of a second unit.

FIG. 10 is a conceptual view illustrating a second example of the second unit.

FIG. 11 is a conceptual view illustrating a third example of the second unit.

FIG. 12 is a table showing a first battery configuration.

FIG. 13 is a table showing a second battery configuration.

FIG. 14 is a table showing a third battery configuration.

FIG. 15 is a conceptual view illustrating the configuration of an evaluation cell.

FIG. 16 is a table showing the configuration of an interposed layer in an evaluation cell.

FIG. 17 is a graph showing evaluation results.

### DESCRIPTION OF THE PREFERRED EMBODIMENTS

### <Terms and Phrases>

Terms such as “comprise”, “include”, and “have”, and other similar terms are open-ended terms. In an open-ended term, in addition to an essential component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤, ≥”. Each of “more than” and “less than” is represented by an inequality symbol without an equality symbol, e.g., “<, >”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

“Interposed layer” collectively refers to a first interposed layer and a second interposed layer. Similarly, “inorganic particles” collectively refer to first inorganic particles and second inorganic particles. “Binder” collectively refers to a first binder and a second binder.

“Coefficient of permeability” refers to a value that is measured in the following manner. Firstly, by FIB-SEM (Focused Ion Beam-Scanning Electron Microscopy), tomographic images of a target (a first interposed layer, a second interposed layer, a positive electrode active material layer, a negative electrode active material layer) are acquired. From the tomographic images, a three-dimensional structure is re-created. Desirably, the pitch in tomography is small. Desirably, the captured area is large. For example, from the viewpoint of the specifications of the FIB-SEM apparatus and the measuring time, the following conditions may be adopted.

Pitch in tomography: 100 nm (or may be smaller than 100 nm)

Size of captured area: 50 μm×30 μm (or may be greater than 50 μm×30 μm)

Magnification: When it is possible to differentiate between particles (solid) and pores in the captured area at the actual size, that magnification is adopted. When it is impossible to differentiate between particles and pores, the magnification is adjusted so as to magnify the diameter of the particles at least three times greater (this number is provided as a guide).

Number of slices: 200 (or may be greater than 200)

Cross-sectional sample: The cross-sectional sample may be embedded in resin for easier differentiation between particles and pores.

Then, the three-dimensional structure is analyzed. With the use of an analytic module “FlowDict” of simulation software “GeoDict” (manufactured by Math 2 Market), the coefficient of permeability is calculated from the three-dimensional structure. The coefficient of permeability is derived by the Stokes equation or the Navier-Stokes equation. Which of the Stokes equation or the Navier-Stokes equation to select may be determined based on the actual measurement data (the relationship between the pressure and the flow rate at the target). When the relationship between the pressure and the flow rate is linear, it is conceivable that the Stokes equation is suitable. When the relationship between the pressure and the flow rate is non-linear, it is conceivable that the Navier-Stokes equation is suitable. Because the coefficient of permeability in the in-plane direction of the target (layer) is intended to be obtained, either the X axis or the Y axis is selected as the axial direction in which the fluid flows. Based on the slicing direction for the cross-sectional sample, either the X axis or the Y axis is selected.

“SP value” refers to a solubility parameter. The SP value is determined by “I. Method to estimate from physical property values” or “II. Method to estimate from the molecular structure” found in a paper titled “Discussion on solubility parameter of additives” appeared in “Paint Research (‘Toryo no Kenkyu’), vol. 152 (issued in October 2010)” issued by Kansai Paint. If the SP value of the target is found in literature, the value in the literature may be adopted.

“D50” refers to a particle size in volume-based particle size distribution (cumulative distribution) at which the cumulative value reaches 50%. The particle size distribution may be measured by laser diffraction.

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. “Al₂O₃” represents a compound that includes Al and O in any molar ratio, unless otherwise specified. For example, the compound may be doped with a trace element. Some of Al and O may be replaced by another element.

“Derivative” refers to a compound that is derived from its original compound by at least one partial modification selected from the group consisting of substituent introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring. A derivative of a polymer compound (a resin material) may also be called “a modified product”.

### <Lithium-Ion Battery>

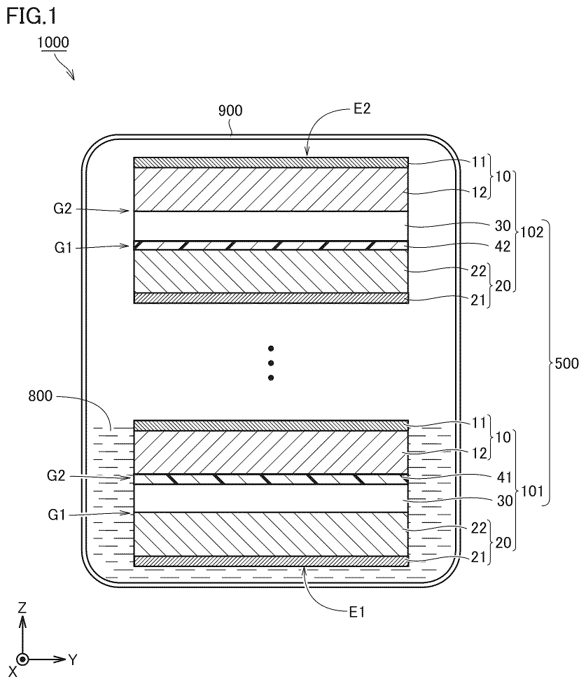

FIG. 1 is a conceptual view illustrating an example of a lithium-ion battery according to the present embodiment. A battery 1000 is a lithium-ion battery. Battery 1000 includes a power generation element 500 and an electrolyte solution 800. Battery 1000 may further include an exterior package 900.

### <Exterior Package>

Exterior package 900 may accommodate power generation element 500 and electrolyte solution 800. Exterior package 900 may have any configuration. Exterior package 900 may be a case made of metal, a pouch made of a metal foil laminated film, and/or the like, for example. Exterior package 900 may have any outer shape. Exterior package 900 may be cylindrical, prismatic, flat, coin-shaped, and/or the like, for example. Exterior package 900 may include Al, Al alloy, and/or the like, for example.

### <Power Generation Element>

Power generation element 500 may have a monopolar structure, or may have a bipolar structure. Power generation element 500 includes a positive electrode 10, a separator 30, a negative electrode 20, a first interposed layer 41, and a second interposed layer 42. Power generation element 500 is a stack-type one. Power generation element 500 has a stacking direction (the Z direction). The stacking direction is parallel to the thickness direction of positive electrode 10, separator 30, and negative electrode 20. The stacking direction may be parallel to the vertical direction. In the stacking direction, positive electrode 10 and negative electrode 20 are alternately stacked. Separator 30 is sandwiched between positive electrode 10 and negative electrode 20. Positive electrode 10 includes a positive electrode current-collecting foil 11 and a positive electrode active material layer 12. Negative electrode 20 includes a negative electrode current-collecting foil 21 and a negative electrode active material layer 22. In a bipolar structure, positive electrode current-collecting foil 11 may be affixed to negative electrode current-collecting foil 21, for example.

### <First Interposed Layer, Second Interposed Layer>

In power generation element 500, at least one of a first gap G1 and a second gap G2 is formed. First gap G1 is a gap formed between the negative electrode active material layer and separator 30. Second gap G2 is a gap formed between the positive electrode active material layer and separator 30. Only one of first gap G1 and second gap G2 may be formed. Both the first gap G1 and the second gap G2 may be formed.

At at least one of first gap G1 and second gap G2, first interposed layer 41 is placed. Further, at at least one of first gap G1 and second gap G2, second interposed layer 42 is placed. For example, it is possible that first interposed layer 41 is placed at second gap G2 and second interposed layer 42 is placed at first gap G1. For example, it is possible that both the first interposed layer 41 and the second interposed layer 42 are placed at first gap G1 and no interposed layer is formed at second gap G2.

The coefficient of permeability through first interposed layer 41 is different from the coefficient of permeability through second interposed layer 42. In other words, the relationship of an expression (1) below is satisfied.

P1≠P2 (1)
P1: Coefficient of permeability of electrolyte solution 800 through first interposed layer 41
P2: Coefficient of permeability of electrolyte solution 800 through second interposed layer 42

When P1 is different from P2 and first interposed layer 41 has a particular positional relationship with second interposed layer 42 in the stacking direction, high-rate resistance is expected to be improved. Power generation element 500 has a first end portion E1 at one end in the stacking direction. Power generation element 500 has a second end portion E2 at the other end in the stacking direction. First interposed layer 41 is closer to first end portion E1 than second interposed layer 42 is. First end portion E1 may be the lower end in the vertical direction, for example. Second end portion E2 may be the upper end in the vertical direction, for example. Electrolyte solution 800 may be distributed more at the first end portion E1 side, for example. At first end portion E1, surplus liquid may be stored. “Surplus liquid” refers to electrolyte solution 800 stored outside the power generation element 500.

P1 may be either greater or smaller than P2. In other words, the relationship of an expression (2) below may be satisfied, for example.

P1>P2 (2)

P1 may be 1×10⁻¹⁵ m² or more, or 1×10⁻¹⁴ m² or more, or 2×10⁻¹⁴ m² or more, or 3×10⁻¹⁴ m² or more, or 4×10⁻¹⁴ m² or more, or 5×10⁻¹⁴ m² or more, or 6×10⁻¹⁴ m² or more, or 7×10⁻¹⁴ m² or more, or 8×10⁻¹⁴ m² or more, or 9×10⁻¹⁴ m² or more, or 1×10⁻¹³ m² or more, for example. P1 may be 1×10⁻¹¹ m² or less, or 1×10⁻¹² m² or less, or 1×10⁻¹³ m² or less, or 5×10⁻¹⁴ m² or less, for example.

P2 may be less than 1×10⁻¹⁵ m², or 1×10⁻¹⁶ m² or less, or 9×10⁻¹⁷ m² or less, or 8×10⁻¹⁷ m² or less, or 7×10⁻¹⁷ m² or less, or 6×10⁻¹⁷ m² or less, or 5×10⁻¹⁷ m² or less, or 4×10⁻¹⁷ m² or less, or 3×10⁻¹⁷ m² or less, or 2×10⁻¹⁷ m² or less, or 1×10⁻¹⁷ m² or less, for example, and P2 may be 1×10⁻¹⁹ m² or more, or 1×10⁻¹⁸ m² or more, or 1×10⁻¹⁷ m² or more, or 5×10⁻¹⁷ m² or more, for example.

The thickness of the interposed layer is not particularly limited. The thickness of the interposed layer may be either smaller or greater than the thickness of separator 30. The thickness of the interposed layer may be from 0.1 to 10 μm, or from 0.5 to 5 μm, or from 1 to 3 μm, for example. The thickness of first interposed layer 41 may be either the same as or different from the thickness of second interposed layer 42.

The porosity of the interposed layer is not particularly limited. The porosity of the interposed layer may be 10% or more, or 20% or more, or 30% or more, or 40% or more, or 50% or more, or 60% or more, for example. The porosity of the interposed layer may be 90% or less, or 80% or less, or 70% or less, or 60% or less, or 50% or less, or 40% or less, or 30% or less, for example. The porosity of first interposed layer 41 may be either the same as or different from the porosity of second interposed layer 42.

The pore distribution in the interposed layer is not particularly limited. The mode value of the pore size in the pore distribution may be 0.1 μm, or 0.5 μm or more, or 1 μm or more, or 1.5 μm or more, or 2 μm or more, or 2.5 μm or more, or 3 μm or more, for example. The mode value of the pore size in the pore distribution may be 5 μm or less, or 4 μm or less, or 3 μm or less, or 2.5 μm or less, or 2 μm or less, for example. The pore distribution in first interposed layer 41 may be either the same as or different from the pore distribution in second interposed layer 42.

For example, the interposed layer may be formed by applying a coating material to the surface of separator 30. For example, the interposed layer may be formed by applying a coating material to the surface of positive electrode active material layer 12 or negative electrode active material layer 22. The composition of the interposed layer is not particularly limited. First interposed layer 41 may include first inorganic particles and a first binder, for example. Second interposed layer 42 may include second inorganic particles and a second binder, for example. The second inorganic particles may be either the same as or different from the first inorganic particles. The second binder may be either the same as or different from the first binder.

The inorganic particles are electrically insulating. The inorganic particles may be resistant against heat, for example. The inorganic particles may include metal oxide and/or the like, for example. Each of the first inorganic particles and the second inorganic particles may independently include at least one selected from the group consisting of boehmite, alumina, zirconia, titania, magnesia, silica, and the like, for example. The particle shape of the inorganic particles is not particularly limited. The particle shape may be spherical, columnar, flake-like, plate-like, needle-like, fibrous, and/or the like, for example. The size of the inorganic particles is not particularly limited. The D50 of the inorganic particles may be from 0.1 to 10 μm, or from 0.5 to 5 μm, or from 1 to 3 μm, for example.

The amount of the binder to be used may be, for example, from 0.1 to 100 parts by mass relative to 100 parts by mass of the inorganic particles. The amount of the binder to be used in first interposed layer 41 may be either the same as or different from that in second interposed layer 42. The composition of the binder is not particularly limited. Each of the first binder and the second binder may independently include at least one selected from the group consisting of polyolefin-based resin, cellulose-based polymer, fluorine-based resin, vinyl-based resin, polyalkylene oxide, and acrylic-based resin. The polyolefin-based resin may include styrene-butadiene rubber (SBR), polyethylene (PE), and/or the like, for example. The SP value of SBR may vary depending on the molar ratio between the styrene monomer and the butadiene monomer. For example, the relationship of “styrene/butadiene=85/15 to 60/40”, or “styrene/butadiene=85/15 to 75/25”, or “styrene/butadiene=75/25 to 60/40” in molar ratio may be satisfied. The cellulose-based polymer may include carboxymethylcellulose (CMC) and/or the like. The fluorine-based resin may include polyvinylidene difluoride (PVDF), polytetrafluoroethylene (PTFE), poly(vinylidene difluoride-co-hexafluoropropylene) (PVDF-HFP), and/or the like, for example. The vinyl-based resin may include polyvinyl alcohol (PVA) and/or the like, for example. The polyalkylene oxide may include polyethylene oxide (PEO) and/or the like, for example. The acrylic-based resin may include a homopolymer of acrylic-based monomers and a copolymer of these, for example. The acrylic-based monomer may include at least one selected from the group consisting of acrylic acid, methacrylic acid, acrylamide, methacrylamide, 2-hydroxyethyl acrylate, 2-hydroxyethyl methacrylate, methyl methacrylate, 2-ethylhexyl acrylate, and butyl acrylate, for example. The acrylic-based resin may include acrylic resin and methacrylic resin, for example. Each of the first binder and the second binder may independently include at least one selected from the group consisting of PVDF, acrylic resin, methacrylic resin, SBR, PVA, and PE, for example.

Permeability of the electrolyte solution through the interposed layer may vary depending on the SP value of the binder, the amount of the binder to be used, and the like. For example, the SP value of the first binder and the second binder may satisfy a particular relationship with the SP value of the solvent in the electrolyte solution. For example, the relationship of an expression (3) below may be satisfied.

Δ1>Δ2 (3)
Δ1: Absolute value of the difference between the SP value of the solvent in the electrolyte solution and the SP value of the first binder
Δ2: Absolute value of the difference between the SP value of the solvent in the electrolyte solution and the SP value of the second binder

The greater the difference in the SP value is, the more actively the electrolyte solution tends to flow into and flow out through the interposed layer. For example, the relationships of an expression (4) and an expression (5) below may be satisfied.

2.5≤Δ1 (4)

Δ2≤2 (5)

Δ1 may be 3 or more, or 3.5 or more, or 4 or more, or 4.5 or more, or 5 or more, or 5.5 or more, for example. Δ1 may be 10 or less, or 8 or less, or 6 or less, or 4 or less, for example. Δ2 may be 1.5 or less, or 1 or less, or 0.5 or less, or 0.1 or less, for example. Δ2 may be 0 or more, or 0.5 or more, or 1 or more, or 1.5 or more, for example.

### <First Unit, Second Unit>

Power generation element 500 may consist of one type of unit (a repeating unit). Power generation element 500 may include a plurality of types of units. Power generation element 500 may include a first unit 101 and a second unit 102, for example. Power generation element 500 may include a plurality of first units 101. Power generation element 500 may include a plurality of second units. The power generation element may include a plurality of first units 101 and a plurality of second units 102. Each of first unit 101 and second unit 102 includes positive electrode 10, separator 30, and negative electrode 20. In the stacking direction, first unit 101 may be closer to first end portion E1 than second unit 102 is. First unit 101 may be in contact with the surplus liquid (electrolyte solution 800). Second unit 102 may not be in contact with the surplus liquid.

First unit 101 may include first interposed layer 41 at at least one of first gap G1 and second gap G2. Second unit 102 may include second interposed layer 42 at at least one of first gap G1 and second gap G2. The coefficient of permeability through first interposed layer 41, (P1), and the coefficient of permeability through second interposed layer 42, (P2), may satisfy the relationship of “P1>P2”, for example.

The configuration of the interposed layer in first unit 101 and second unit 102 may be changed depending on the relationship between the coefficient of permeability through positive electrode active material layer 12, (Pc), and the coefficient of permeability through negative electrode active material layer 22, (Pa).

For example, first unit 101 may have a configuration in which the salt concentration of electrolyte solution 800 can become uniform between inside and outside of power generation element 500. For example, in first unit 101, the interposed layer may be placed so as to make the sum of the salt concentration of electrolyte solution 800 flowing out from positive electrode active material layer 12 side and the salt concentration of electrolyte solution 800 flowing out from negative electrode active material layer 22 side be close to the salt concentration of the surplus liquid.

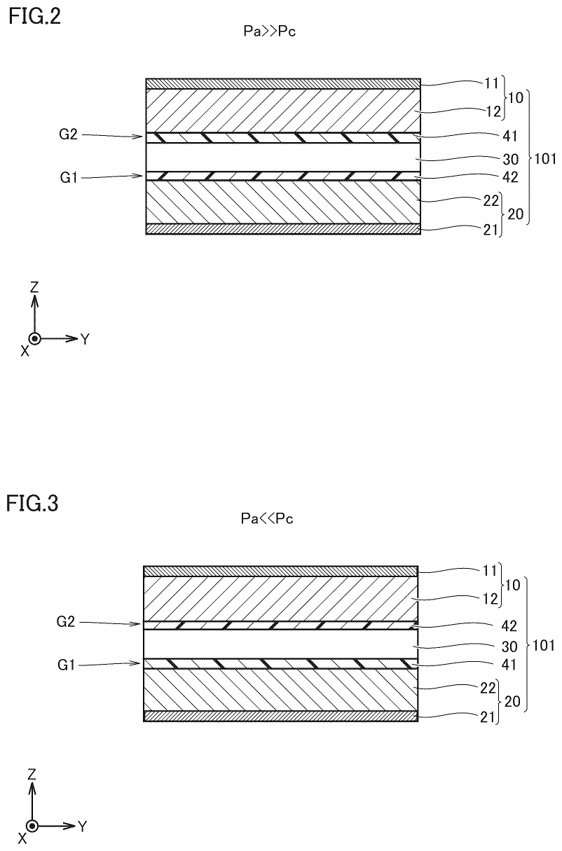

FIG. 2 is a conceptual view illustrating a first example of the first unit. “Pa>>Pc” means that the coefficient of permeability through negative electrode active material layer 22, (Pa), is much greater than the coefficient of permeability through positive electrode active material layer 12, (Pc). When the relationship of “Pa>>Pc” is satisfied, Pa may be at least twice greater than Pc, or at least five times greater than Pc, or at least ten times greater than Pc, or at least twenty times greater than Pc, or at least fifty times greater than Pc, or at least a hundred times greater than Pc, for example. In first unit 101, when the relationship of “Pa>>Pc” is satisfied, for example, first interposed layer 41 may be placed at second gap G2 and second interposed layer 42 may be placed at first gap G1. The coefficient of permeability through first interposed layer 41, (P1), and the coefficient of permeability through second interposed layer 42, (P2), may satisfy the relationship of “P1>P2”, for example.

FIG. 3 is a conceptual view illustrating a second example of the first unit. In first unit 101, when the relationship of “Pa<<Pc” is satisfied, for example, second interposed layer 42 may be placed at second gap G2 and first interposed layer 41 may be placed at first gap G1. The coefficient of permeability through first interposed layer 41, (P1), and the coefficient of permeability through second interposed layer 42, (P2), may satisfy the relationship of “P1>P2”, for example.

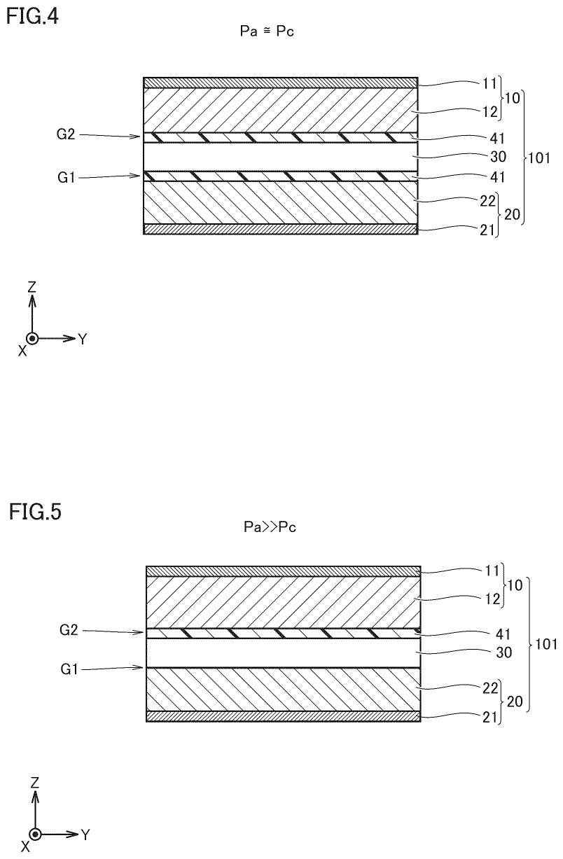

FIG. 4 is a conceptual view illustrating a third example of the first unit. “Pa˜Pc” means that the coefficient of permeability through positive electrode active material layer 12, (Pc), is close to the coefficient of permeability through negative electrode active material layer 22, (Pa). When the relationship of “Pa˜Pc” is satisfied, the relationship of “0.75≤Pa/Pc≤1.25” or “0.9≤Pa/Pc≤1.1” may be satisfied, for example. In first unit 101, when the relationship of “Pa˜Pc” is satisfied, for example, first interposed layer 41 may be placed at each of first gap G1 and second gap G2.

FIG. 5 is a conceptual view illustrating a fourth example of the first unit. In first unit 101, when the relationship of “Pa>>Pc” is satisfied, for example, first interposed layer 41 may be placed only at second gap G2.

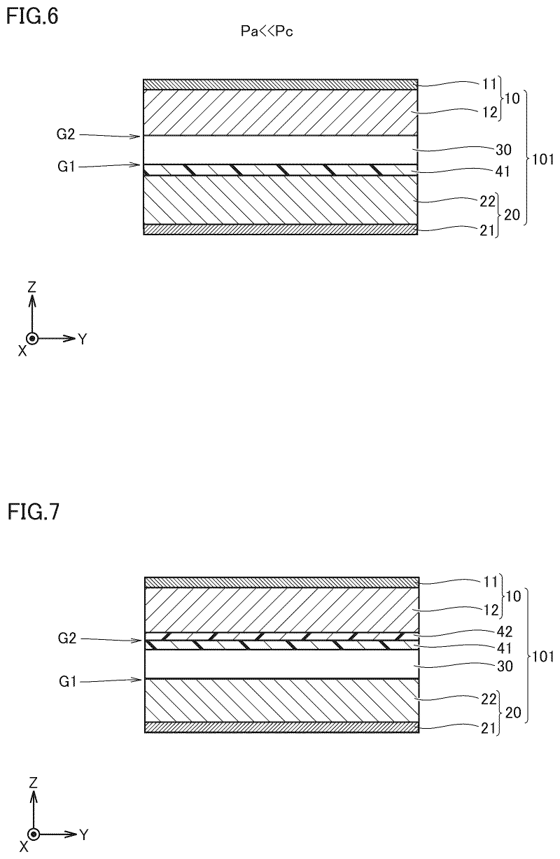

FIG. 6 is a conceptual view illustrating a fifth example of the first unit. In first unit 101, when the relationship of “Pa<<Pc” is satisfied, for example, first interposed layer 41 may be placed only at first gap G1.

FIG. 7 is a conceptual view illustrating a sixth example of the first unit. In first unit 101, both the first interposed layer 41 and the second interposed layer 42 may be placed only at second gap G2, for example. Second interposed layer 42 may be placed between first interposed layer 41 and positive electrode active material layer 12. First interposed layer 41 may be placed between second interposed layer 42 and positive electrode active material layer 12. The coefficient of permeability through first interposed layer 41, (P1), and the coefficient of permeability through second interposed layer 42, (P2), may satisfy the relationship of “P1>P2”, for example.

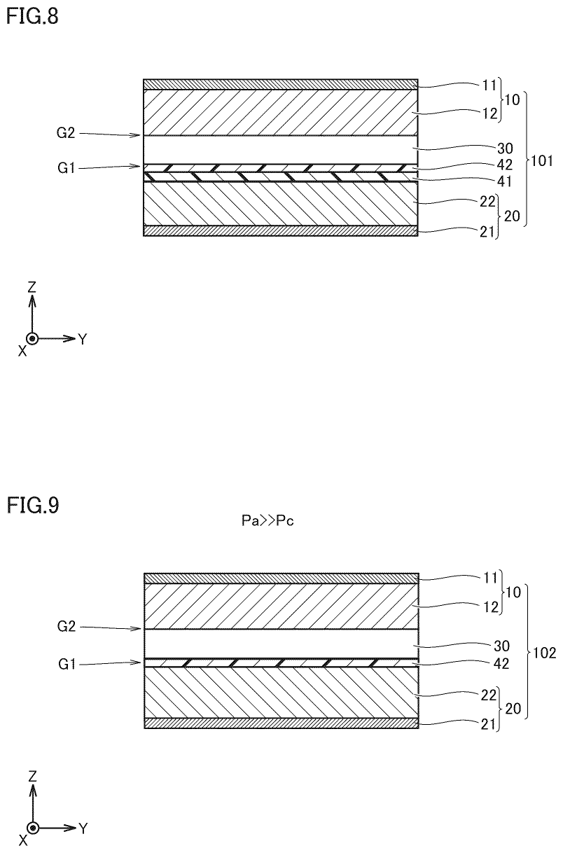

FIG. 8 is a conceptual view illustrating a seventh example of the first unit. In first unit 101, both the first interposed layer 41 and the second interposed layer 42 may be placed only at first gap G1, for example. Second interposed layer 42 may be placed between first interposed layer 41 and negative electrode active material layer 22. First interposed layer 41 may be placed between second interposed layer 42 and negative electrode active material layer 22. The coefficient of permeability through first interposed layer 41, (P1), and the coefficient of permeability through second interposed layer 42, (P2), may satisfy the relationship of “P1>P2”, for example.

Second unit 102 may have a configuration that does not allow easy flowing-out of electrolyte solution 800, for example. FIG. 9 is a conceptual view illustrating a first example of the second unit. In second unit 102, when the relationship of “Pa>>Pc” is satisfied, for example, second interposed layer 42 may be placed at first gap G1.

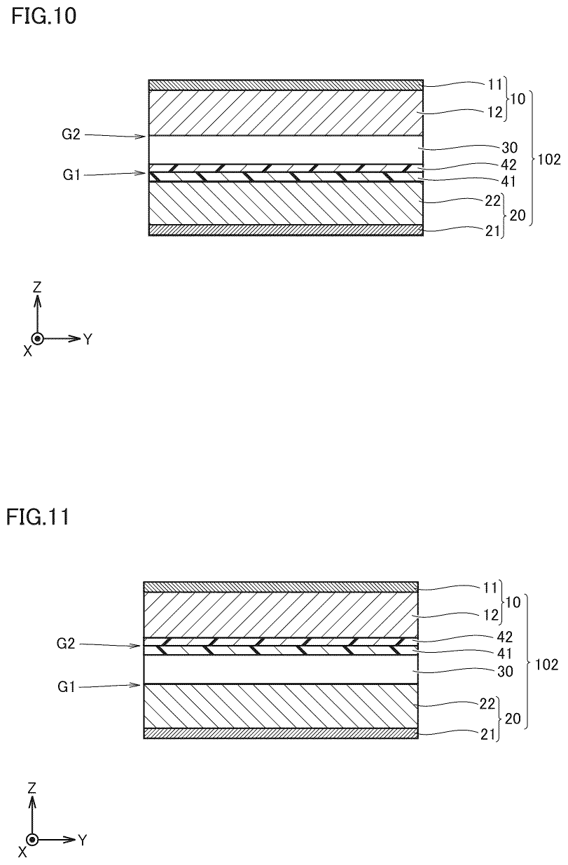

FIG. 10 is a conceptual view illustrating of a second example of the second unit. In second unit 102, both the first interposed layer 41 and the second interposed layer 42 may be placed only at first gap G1, for example. Second interposed layer 42 may be placed between first interposed layer 41 and negative electrode active material layer 22. First interposed layer 41 may be placed between second interposed layer 42 and negative electrode active material layer 22. The coefficient of permeability through first interposed layer 41, (P1), and the coefficient of permeability through second interposed layer 42, (P2), may satisfy the relationship of “P1>P2”, for example.

FIG. 11 is a conceptual view illustrating a third example of the second unit. In second unit 102, both the first interposed layer 41 and the second interposed layer 42 may be placed only at second gap G2, for example. Second interposed layer 42 may be placed between first interposed layer 41 and positive electrode active material layer 12. First interposed layer 41 may be placed between second interposed layer 42 and positive electrode active material layer 12. The coefficient of permeability through first interposed layer 41, (P1), and the coefficient of permeability through second interposed layer 42, (P2), may satisfy the relationship of “P1>P2”, for example.

### <Positive Electrode>

Positive electrode 10 includes positive electrode current-collecting foil 11 and positive electrode active material layer 12. Positive electrode current-collecting foil 11 supports positive electrode active material layer 12. Positive electrode current-collecting foil 11 may have a thickness from 5 to 50 μm, for example. Positive electrode current-collecting foil 11 may include at least one selected from the group consisting of Al, Mn, Ti, Fe, and Cr, for example. Positive electrode current-collecting foil 11 may include Al foil, Al alloy foil, Ti foil, stainless steel (SUS) foil, and/or the like, for example.

Between positive electrode current-collecting foil 11 and positive electrode active material layer 12, an intermediate layer may be formed. The intermediate layer does not include a positive electrode active material. The intermediate layer may have a thickness from 0.1 to 5 μm, for example. The intermediate layer may include a conductive material, an insulation material, a binder, and/or the like, for example. The conductive material may include carbon black and/or the like, for example. The insulation material may include alumina, boehmite, aluminum hydroxide, and/or the like, for example. The binder may include PVDF and/or the like, for example.

Positive electrode active material layer 12 is placed on the surface of positive electrode current-collecting foil 11. Positive electrode active material layer 12 may be placed on only one side of positive electrode current-collecting foil 11. Positive electrode active material layer 12 may be placed on both sides of positive electrode current-collecting foil 11. The thickness of positive electrode active material layer 12 may be from 10 to 1000 μm, or from 50 to 500 μm, or from 100 to 300 μm, for example. Positive electrode active material layer 12 includes a positive electrode active material. Positive electrode active material layer 12 may further include a conductive material, a binder, and the like, for example.

The amount of the conductive material to be used may be, for example, from 0.1 to 10 parts by mass relative to 100 parts by mass of the positive electrode active material. The conductive material may include any component. The conductive material may include at least one selected from the group consisting of graphite, acetylene black (AB), Ketjenblack (registered trademark), vapor grown carbon fibers (VGCFs), carbon nanotubes (CNTs), and graphene flakes (GFs), for example. The CNTs may include at least one selected from the group consisting of single-walled CNTs (SWCNTs) and multi-walled CNTs (MWCNTs).

The amount of the binder to be used may be, for example, from 0.1 to 10 parts by mass relative to 100 parts by mass of the positive electrode active material. The binder may include any component. The binder may include at least one selected from the group consisting of PVDF, PVDF-HFP, PTFE, CMC, polyacrylic acid (PAA), PVA, polyvinylpyrrolidone (PVP), polyoxyethylene alkyl ether, and derivatives of these, for example.

Positive electrode active material layer 12 may further include an inorganic filler, an organic filler, a solid electrolyte, a surface modifier, a dispersant, a lubricant, a flame retardant, a protective agent, a flux, a coupling agent, an adsorbent, and/or the like, for example. Positive electrode active material layer 12 may include polyoxyethylene allylphenyl ether phosphate, zeolite, silane coupling agent, MoS₂, WO₃, and/or the like, for example.

### Positive Electrode Active Material

The positive electrode active material may be in particle form, for example. The D50 of the positive electrode active material may be from 1 to 30 μm, or from 10 to 20 μm, or from 1 to 10 μm, for example. The positive electrode active material may include any component. The positive electrode active material may include a transition metal oxide, a polyanion compound, and/or the like, for example. In a single particle (positive electrode active material), the composition may be uniform, or may be non-uniform. For example, there may be a gradient in the composition from the surface of the particle toward the center. The composition may change continuously, or may change non-continuously (in steps).

### Transition Metal Oxide (Space Group R-3m)

The transition metal oxide may have any crystal structure. For example, the transition metal oxide may include a crystal structure that belongs to a space group R-3m and/or the like. For example, a compound represented by the general formula “LiMO₂” may have a crystal structure that belongs to a space group R-3m. The transition metal oxide may be represented by the following general formula, for example.

Li₁₋ₐNiₓM₁₋ₓO₂

In the above formula, the relationships of −0.5≤a≤0.5, 03≤x≤1 are satisfied. M may include, for example, at least one selected from the group consisting of Co, Mn, and Al. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied. For example, the relationship of −0.4≤a≤0.4, −0.3≤a≤0.3, −0.2≤a≤0.2, or −0.1≤a≤0.1 may be satisfied.

The transition metal oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

### NCM

The transition metal oxide may be represented by the following general formula, for example. A compound represented by the following general formula may also be called “NCM”.

Li₁₋ₐNiₓCo_{y}Mn_{z}O₂

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}CO_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂.

### NCA

The transition metal oxide may be represented by the following general formula, for example. A compound represented by the following general formula may also be called “NCA”.

Li₁₋ₐNiₓCo_{y}Al₂O₂

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

### Multi-Component System

The positive electrode active material may include two or more NCMs and/or the like, for example. The positive electrode active material may include NCM (0.6≤x) and NCM (x<0.6), for example. “NCM (0.6≤x)” refers to a compound in which x (Ni ratio) in the general formula “Li₁₋ₐNiₓCo_{y}Mn_{z}O₂” is 0.6 or more. NCM (0.6≤x) may also be called “a high-nickel material”, for example. NCM (0.6≤x) includes LiNi_{0.8}Co_{0.1}Mn_{0.1}O₂ and/or the like, for example. “NCM (x<0.6)” refers to a compound in which x (Ni ratio) in the general formula “Li₁₋ₐNiₓCo_{y}Mn_{z}O₂” is less than 0.6. NCM (x<0.6) includes LiNi_{1/3}Co_{1/3}Mn_{1/3}O₂ and/or the like, for example. The mixing ratio (mass ratio) between NCM (0.6≤x) and NCM (x<0.6) may be “NCM (0.6≤x)/NCM (x<0.6)=9/1 to 1/9”, or “NCM (0.6≤x)/NCM (x<0.6)=9/1 to 4/6”, or “NCM (0.6≤x)/NCM (x<0.6)=9/1 to 3/7”, for example.

The positive electrode active material may include NCA and NCM, for example. The mixing ratio (mass ratio) between NCA and NCM may be “NCA/NCM=9/1 to 1/9”, or “NCA/NCM=9/1 to 4/6”, or “NCA/NCM=9/1 to 3/7”, for example. Between NCA and NCM, the Ni ratio may be the same or may be different. The Ni ratio of NCA may be more than the Ni ratio of NCM. The Ni ratio of NCA may be less than the Ni ratio of NCM.

### Transition Metal Oxide (Space Group C2/m)

The transition metal oxide may include a crystal structure that belongs to a space group C2/m and/or the like, for example. The transition metal oxide may be represented by the following general formula, for example.

Li₂MO₃

In the above formula, M may include at least one selected from the group consisting of Ni, Co, Mn, and Fe, for example. The positive electrode active material may include a mixture of LiMO₂ (space group R-3m) and Li₂MO₃ (space group C2/m), for example. The positive electrode active material may include a solid solution that is formed of LiMO₂ and Li₂MO₃ (Li₂MO₃-LiMO₂), and/or the like, for example.

### Transition Metal Oxide (Space Group Fd-3m)

The transition metal oxide may include a crystal structure that belongs to a space group Fd-3m and/or the like, for example. The transition metal oxide may be represented by the following general formula, for example.

LiMn₂₋ₓMₓO₄

In the above formula, the relationship of 0≤x≤2 is satisfied. M may include, for example, at least one selected from the group consisting of Ni, Fe, and Zn.

LiM₂O₄ (space group Fd-3m) may include, for example, at least one selected from the group consisting of LiMn₂O₄ and LiMn_{1.5}Ni_{0.04}. The positive electrode active material may include a mixture of LiMO₂ (space group R-3m) and LiM₂O₄ (space group Fd-3m), for example. The mixing ratio (mass ratio) between LiMO₂ (space group R-3m) and LiM₂O₄ (space group Fd-3m) may be “LiMO₂/LiM₂O₄=9/1 to 1/9”, or “LiMO₂/LiM₂O₄=9/1 to 5/5”, or “LiMO₂/LiM₂O₄=9/1 to 7/3”, for example.

### Polyanion Compound

The polyanion compound may include a phosphoric acid salt (such as LiFePO₄, for example), a silicic acid salt, a boric acid salt, and/or the like, for example. The polyanion compound may be represented by any of the following general formulae, for example.

LiMPO₄

Li₂₋ₓMPO₄F

Li₂MSiO₄

LiMBO₃

In the above general formulae, M may include at least one selected from the group consisting of Fe, Mn, and Co, for example. In the above general formula “Li₂₋ₓMPO₄F”, the relationship of 0≤x≤2 may be satisfied, for example.

The positive electrode active material may include a mixture of LiMO₂ (space group R-3m) and the polyanion compound, for example. The mixing ratio (mass ratio) between LiMO₂ (space group R-3m) and the polyanion compound may be “LiMO₂/(polyanion compound)=9/1 to 9/1”, or “LiMO₂/(polyanion compound)=9/1 to 5/5”, or “LiMO₂/(polyanion compound)=9/1 to 7/3”, for example.

### Dopant

To the positive electrode active material, a dopant may be added. The dopant may be diffused throughout the entire particle, or may be locally distributed. For example, the dopant may be locally distributed on the particle surface. The dopant may be a substituted solid solution atom, or may be an intruding solid solution atom. The amount of the dopant to be added (the molar fraction relative to the total amount of the positive electrode active material) may be from 0.01 to 5%, or may be from 0.1 to 3%, or may be from 0.1 to 1%, for example. A single type of dopant may be added, or two or more types of dopant may be added. The two or more dopants may form a complex.

The dopant may include, for example, at least one selected from the group consisting of B, C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

For example, to NCA, a combination of “Zr, Mg, W, Sm”, a combination of “Ti, Mn, Nb, Si, Mo”, or a combination of “Er, Mg” may be added. For example, to NCM, Ti may be added. For example, to NCM, a combination of “Zr, W”, a combination of “Si, W”, or a combination of “Zr, W, Al, Ti, Co” may be added.

### Surface Coating

The positive electrode active material may be in the form of composite particles. The composite particle may include a core particle and a covering layer, for example. The core particle includes the positive electrode active material. The covering layer covers at least part of the surface of the core particle. The thickness of the covering layer may be from 1 to 3000 nm, or from 5 to 2000 nm, or from 10 to 1000 nm, or from 10 to 100 nm, or from 10 to 50 nm, for example. The thickness of the covering layer may be measured in an SEM image of a cross section of the particle, for example. More specifically, the composite particle is embedded in a resin material to prepare a sample. With the use of an ion milling apparatus, a cross section of the sample is exposed. The cross section of the sample is examined by an SEM. For each of ten composite particles, the thickness of the covering layer is measured in twenty fields of view. The arithmetic mean of a total of these 200 thickness measurements is used.

The ratio of the part of the surface of the core particle covered by the covering layer is also called “a covering rate”. The covering rate may be 1% or more, or 10% or more, or 30% or more, or 50% or more, or 70% or more, for example. The covering rate may be 100% or less, or 90% or less, or 80% or less, for example.

For example, the covering rate may be measured by XPS (X-ray Photoelectron Spectroscopy). A powder sample consisting of the composite particle is set in the XPS. Narrow scan analysis is carried out. The measurement data is processed with analysis software. The measurement data is analyzed to detect a plurality of types of elements. From the area of each peak, the ratio of the detected element is determined. By the following equation, the covering rate is determined.

γ={I₁/(I₀+I₁)}×100
γ: Covering rate [%]
I₀: Ratio of element attributable to core particle
I₁: Ratio of element attributable to covering layer

For example, when the core particle includes NCM, I₀ represents the total ratio of the elements “Ni, Co, Mn”. For example, when the core particle includes NCA, I₀ represents the total ratio of the elements “Ni, Co, Al”. For example, when the covering layer includes P and B, I₁ represents the total ratio of the elements “P, B”.

The covering layer may include any component. The covering layer may include an elementary substance, organic matter, an inorganic acid salt, an organic acid salt, a hydroxide, an oxide, a carbide, a nitride, a sulfide, a halide, and/or the like, for example. The covering layer may include, for example, at least one selected from the group consisting of B, Al, W, Zr, Ti, Co, F, lithium compound (such as Li₂CO₃, LiHCO₃, LiOH, Li₂O, for example), tungsten oxide (such as WO₃, for example), titanium oxide (such as TiO₂, for example), zirconium oxide (such as ZrO₂, for example), boron oxide, boron phosphate (such as BPO₄, for example), aluminum oxide (such as Al₂O₃, for example), boehmite, aluminum hydroxide, phosphoric acid salt [such as Li₃PO₄, (NH₄)₃PO₄, AlPO₄, for example], boric acid salt (such as Li₂B₄O₇, LiBO₃, for example), polyacrylic acid salt (such as Li salt, Na salt, NH₄ salt), acetic acid salt (such as Li salt, for example), CMC (such as CMC-Na, CMC-Li, CMC-NH₄), LiNbO₃, Li₂TiO₃, and Li-containing halide (such as LiAlCl₄, LiTiAlF₆, LiYBr₆, LiYCl₆, for example).

### Hollow Particles, Solid Particles

Each of a hollow particle and a solid particle is a secondary particle. In a “hollow particle”, the area of the central cavity occupies at least 30% of the entire cross-sectional area of the particle in a cross-sectional image of the particle. The proportion of the cavity in a hollow particle may be 40% or more, or 50% or more, or 60% or more, for example. In a “solid particle”, the area of the central cavity occupies less than 30% of the entire cross-sectional area of the particle in a cross-sectional image of the particle. The proportion of the cavity in a solid particle may be 20% or less, or 10% or less, or 5% or less, for example. The positive electrode active material may be hollow particles, or may be solid particles. A mixture of hollow particles and solid particles may be used. The mixing ratio (mass ratio) between hollow particles and solid particles may be “(hollow particles)/(solid particles)=1/9 to 9/1”, or “(hollow particles)/(solid particles)=2/8 to 8/2”, or “(hollow particles)/(solid particles)=3/7 to 7/3”, or “(hollow particles)/(solid particles)=4/6 to 6/4”, for example.

### Large Particles, Small Particles

The active material may have a unimodal particle size distribution (based on the number), for example. The active material may have a multimodal particle size distribution, for example. The active material may have a bimodal particle size distribution, for example. That is, the active material may include large particles and small particles. When the particle size distribution is bimodal, the particle size corresponding to the peak top of the larger particle size is regarded as the particle size of the large particles, (d_{L}). The particle size corresponding to the peak top of the smaller particle size is regarded as the particle size of the small particles, (d_{S}). The particle size ratio (d_{L}/d_{S}) may be from 2 to 10, or from 2 to 5, or from 2 to 4, for example. d_{L} may be from 8 to 20 μm, or from 8 to 15 μm, for example. d_{S} may be from 1 to 10 μm, or from 1 to 5 μm, for example.

For example, with the use of waveform analysis software, peak separating processing may be carried out for the particle size distribution. The ratio between the peak area of the large particles, (S_{L}), and the peak area of the small particles, (S_{S}), may be “S_{L}/S_{S}=1/9 to 9/1”, or “S_{L}/S_{S}=5/5 to 9/1”, or “S_{L}/S_{S}=7/3 to 9/1”, for example.

The number-based particle size distribution is measured by a microscope method. From the active material layer, a plurality of cross-sectional samples are taken. The cross-sectional sample may include a cross section vertical to the surface of the active material layer, for example. By ion milling and/or the like, for example, cleaning is carried out to the side that is to be observed. By SEM, the cross-sectional sample is examined. The magnification for the examination is adjusted in such a way that 10 to 100 particles are contained within the examination field of view. The Feret diameters of all the particles in the image are measured. “Feret diameter” refers to the distance between two points located farthest apart from each other on the outline of the particle. The plurality of the cross-sectional samples are examined to obtain a total of 1000 or more Feret diameters. From the 1000 or more Feret diameters, number-based particle size distribution is created.

The bimodal particle size distribution may be formed by two types of particles mixed together. These two types of particles have different particle size distributions. For example, the two types of particles may have different D50. The sample to be measured is powder. The D50 of the large particles may be from 8 to 20 μm, or from 8 to 15 μm, for example. The D50 of the small particles may be from 1 to 10 μm, or from 1 to 5 μm, for example. The ratio of the D50 of the large particles to the D50 of the small particles may be from 2 to 10, or from 2 to 5, or from 2 to 4, for example. The mixing ratio (mass ratio) between the large particles and the small particles may be “(large particles)/(small particles)=1/9 to 9/1”, or “(large particles)/(small particles)=5/5 to 9/1”, or “(large particles)/(small particles)=7/3 to 9/1”, for example.

The large particles and the small particles may have the same composition, or may have different compositions. For example, the large particles may be NCA and the small particles may be NCM. For example, the large particles may be NCM (0.6≤x) and the small particles may be NCM (x<0.6).

### <Negative Electrode>

Negative electrode 20 includes negative electrode current-collecting foil 21 and negative electrode active material layer 22. Negative electrode current-collecting foil 21 supports negative electrode active material layer 22. Negative electrode current-collecting foil 21 may have a thickness from 5 to 50 μm, for example. Negative electrode current-collecting foil 21 may include at least one selected from the group consisting of Cu and Ni, for example. Negative electrode current-collecting foil 21 may include Cu foil, Cu alloy foil, Ni foil, and/or the like, for example.

Negative electrode active material layer 22 is placed on the surface of negative electrode current-collecting foil 21. Negative electrode active material layer 22 may be placed on only one side of negative electrode current-collecting foil 21. Negative electrode active material layer 22 may be placed on both sides of negative electrode current-collecting foil 21. The thickness of negative electrode active material layer 22 may be from 10 to 1000 μm, or from 50 to 500 μm, or from 100 to 300 μm, for example. Negative electrode active material layer 22 includes a negative electrode active material. Negative electrode active material layer 22 may further include a conductive material, a binder, and the like, for example.

The amount of the conductive material to be used may be, for example, from 0.1 to 10 parts by mass relative to 100 parts by mass of the negative electrode active material. The conductive material may include any component. The conductive material may include at least one selected from the group consisting of AB, Ketjenblack (registered trademark), VGCFs, CNTs, and GFs, for example.

The amount of the binder to be used may be, for example, from 0.1 to 10 parts by mass relative to 100 parts by mass of the negative electrode active material. The binder may include any component. The binder may include, for example, at least one selected from the group consisting of SBR, acrylate butadiene rubber (ABR), sodium alginate, CMC (such as CMC-H, CMC-Na, CMC-Li, CMC-NH₄), PAA (such as PAA-H, PAA-Na, PAA-Li), polyacrylonitrile (PAN), PVDF, PTFE, acrylic resin, methacrylic resin, PVP, PVA, and derivatives of these. For example, the expression “CMC-Na” refers to a Na salt of CMC. For example, the expression “CMC-H” refers to an acid-type CMC. The same applies to “PAA-Na” and the like.

Negative electrode active material layer 22 may further include an inorganic filler, an organic filler, a solid electrolyte, a surface modifier, a dispersant, a lubricant, a flame retardant, a protective agent, a flux, a coupling agent, an adsorbent, and/or the like, for example. Negative electrode active material layer 22 may include a layered silicate (such as smectite, montmorillonite, bentonite, hectorite), an inorganic filler (such as solid alumina, hollow silica, boehmite), a polysiloxane compound, and/or the like, for example.

### Negative Electrode Active Material

The negative electrode active material may be in particle form, or may be in sheet form, for example. The D50 of the negative electrode active material may be from 1 to 30 μm, or from 10 to 20 μm, or from 1 to 10 μm, for example.

### Carbon-Based Active Material

The negative electrode active material may include a carbon-based active material, for example. The carbon-based active material may include at least one selected from the group consisting of graphite, soft carbon, and hard carbon, for example. The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The graphite may include a dopant. The dopant may include, for example, at least one selected from the group consisting of B, N, P, Li, and Ca. The amount thereof to be added in molar fraction may be from 0.01 to 5%, or from 0.1 to 3%, or from 0.1 to 1%, for example.

The surface of the graphite may be covered with amorphous carbon, for example. The surface of the graphite may be covered with another type of material, for example. This another type of material may include, for example, at least one selected from the group consisting of P, W, Al, and O. The another type of material may include, for example, at least one selected from the group consisting of Al(OH)₃, AlOOH, Al₂O₃, WO₃, Li₂CO₃, LiHCO₃, and Li₃PO₄.

### Alloy-Based Active Material

The negative electrode active material may include an alloy-based active material, for example. The negative electrode active material may include, for example, at least one selected from the group consisting of Si, Li silicate, SiO, Si-based alloy, Sn, SnO, and Sn-based alloy.

SiO may be represented by the following general formula, for example.

SiOₓ

In the formula, the relationship of 0<x<2 is satisfied. For example, the relationship of 0.5≤x≤1.5 or 0.8≤x≤1.2 may be satisfied.

Li silicate may include at least one selected from the group consisting of Li₄SiO₄, Li₂SiO₃, Li₂Si₂O₅, and Li₂SiO₆, for example. The negative electrode active material may include a mixture of Si and Li silicate, for example. The mixing ratio (mass ratio) may be “Si/(Li silicate)=1/9 to 9/1”, or “Si/(Li silicate)=2/8 to 8/2”, or “Si/(Li silicate)=3/7 to 7/3”, or “Si/(Li silicate)=4/6 to 6/4”, for example.

The alloy-based active material (such as Si, SiO) may include an additive. The additive may be a substituted solid solution atom or an intruding solid solution atom, for example. The additive may be an adherent adhered to the surface of the alloy-based active material. The adherent may be an elementary substance, an oxide, a carbide, a nitride, a halide, and/or the like, for example. The amount to be added may be, in molar fraction, from 0.01 to 5%, or from 0.1 to 3%, or from 0.1 to 1%, for example. The additive may include, for example, at least one selected from the group consisting of Li, Na, K, Rb, Be, Mg, Ca, Sr, Fe, Ba, B, Al, Ga, In, C, Ge, Sn, Pb, N, P, As, Y, Sb, and S. That is, SiO may be doped with Mg and/or Na. For example, Mg silicate and/or Na silicate may be formed. For example, boron oxide (such as B₂O₃, for example), yttrium oxide (such as Y₂O₃, for example), and/or the like may be added to SiO.

### Si—C Composite Material

The negative electrode active material may include a composite material of the carbon-based active material (such as graphite) and the alloy-based active material (such as Si), for example. A composite material including Si and carbon may also be called “an Si—C composite material”. For example, Si microparticles may be dispersed inside carbon particles. For example, Si microparticles may be dispersed inside graphite particles. For example, Li silicate particles may be covered with a carbon material (such as amorphous carbon).

Other Active Materials The negative electrode active material may include, for example, at least one selected from the group consisting of Li metal, Li-based alloy, and Li₄Ti₅O₁₂. The negative electrode active material may include Li foil and/or the like, for example.

### <Separator>

Separator 30 is capable of separating positive electrode 10 from negative electrode 20. Separator 30 is electrically insulating. Separator 30 may include a resin film, for example. The resin film is porous. The resin film may include a microporous film, a nonwoven fabric, and/or the like, for example. The resin film includes a resin skeleton. The resin skeleton may be continuous in mesh form, for example. Gaps in the resin skeleton form pores. The average pore size of the resin film may be from 0.01 to 1 μm, or from 0.1 to 0.5 μm, for example. “Average pore size” may be measured by mercury porosimetry. The Gurley value of the resin film may be from 50 to 250 s/100 cm³, for example. “Gurley value” may be measured by a Gurley test method.

The resin film may include, for example, at least one selected from the group consisting of an olefin-based resin, a polyurethane-based resin, a polyamide-based resin, a cellulose-based resin, a polyether-based resin, an acrylic-based resin, a polyester-based resin, and the like. The resin film may include, for example, at least one selected from the group consisting of PE, polypropylene (PP), polyamide (PA), polyamide-imide (PAI), polyimide (PI), aromatic polyamide (aramid), polyphenylene ether (PPE), and derivatives of these. The resin film may be formed by stretching, phase separation, and/or the like, for example. The thickness of the resin film may be from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

### <Electrolyte Solution>

The electrolyte solution is a liquid electrolyte. The electrolyte solution includes a supporting salt and a solvent. The supporting salt is also called “a supporting electrolyte”. The concentration of the supporting salt (salt concentration) may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The supporting salt may include an inorganic acid salt, an imide salt, an oxalato complex, a halide, and/or the like, for example. The supporting salt may include at least one selected from the group consisting of LiPF₆, LiBF₄, LiClO₄, LiAsF₆, LiSbF₆, LiN(SO₂F)₂ “LiFSI”, LiN(SO₂CF₃)₂ “LiTFSI”, LiB(C₂O₄)₂ “LiBOB”, LiBF₂(C₂O₄) “LiDFOB”, LiPF₂(C₂O₄)₂ “LiDFOP”, LiPO₂F₂, FSO₃Li, LiI, LiBr, and derivatives of these, for example.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio (volume ratio) between the cyclic carbonate and the chain carbonate may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio (volume ratio) between the cyclic carbonate and the fluorinated cyclic carbonate may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

V_{EC}+V_{FEC}+V_{EMC}+V_{DMC}+V_{DEC}=10

In the equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC=3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

The electrolyte solution may include an ether-based solvent. The electrolyte solution may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite (ES), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the supporting salt and the solvent may be used as a trace component (an additive). The additive may include, for example, at least one selected from the group consisting of LiBF₄, LiFSI, LiTFSI, LiBOB, LIDFOB, LiDFOP, LiPO₂F₂, FSO₃Li, LiI, LiBr, HFE, DOX, PC, FEC, and derivatives of these.

The electrolyte solution may include an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

### <Battery Configuration>

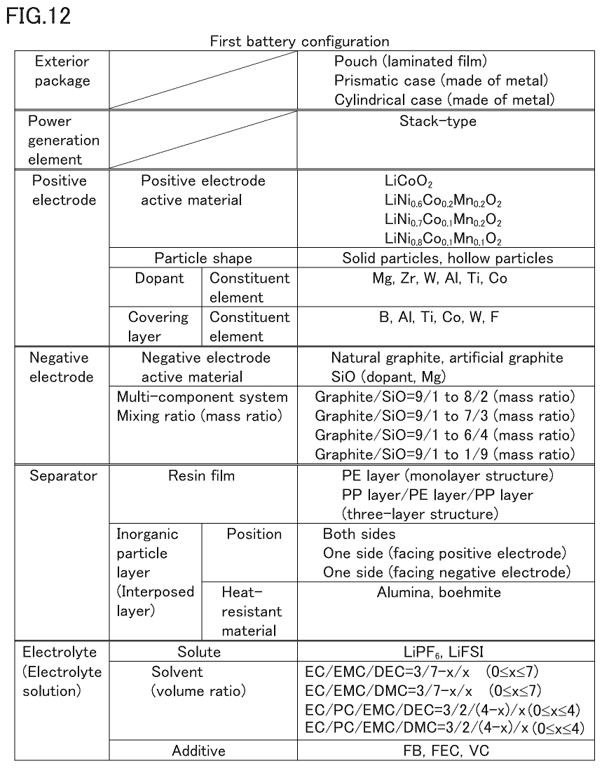

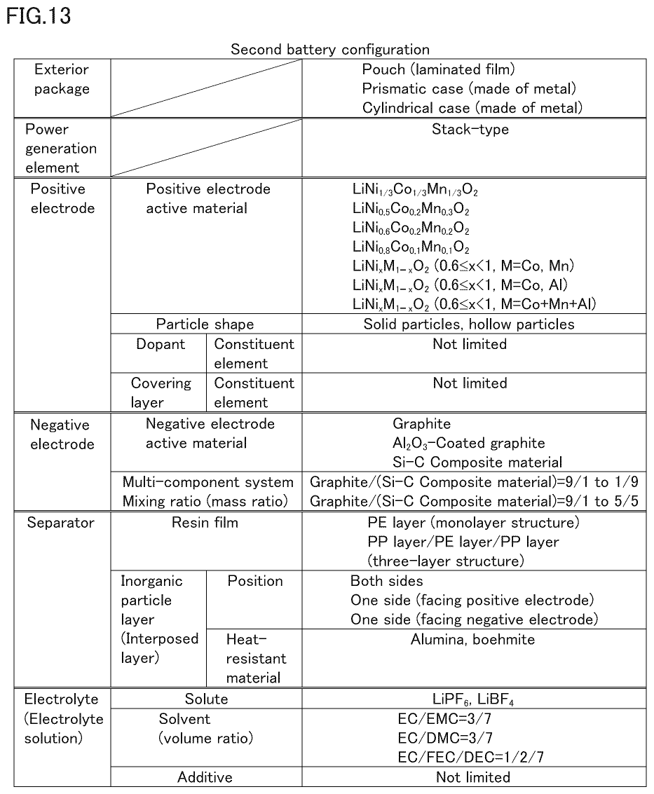

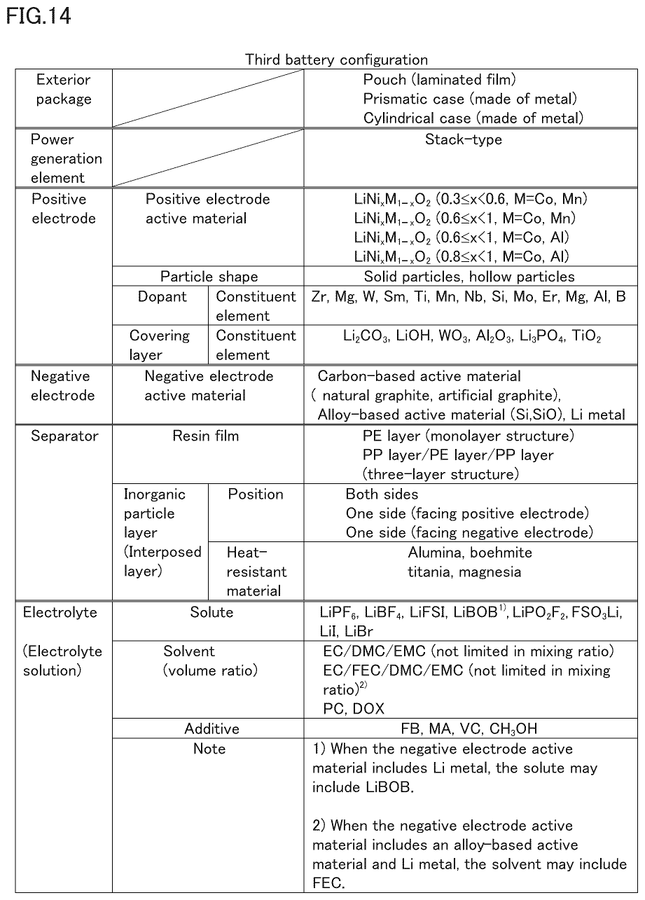

FIG. 12 is a table showing a first battery configuration. FIG. 13 is a table showing a second battery configuration. FIG. 14 is a table showing a third battery configuration. In each table, when a plurality of materials are described in a single cell, this description is intended to mean one of them as well as a combination of them. For example, when materials “α, β, γ” are described in a single cell, this description is intended to mean “at least one selected from the group consisting of α, β, and γ”.

Certain elements may be extracted from the first battery configuration, the second battery configuration, and the third battery configuration and optionally combined together.

### EXAMPLES

### <Evaluation Cell>

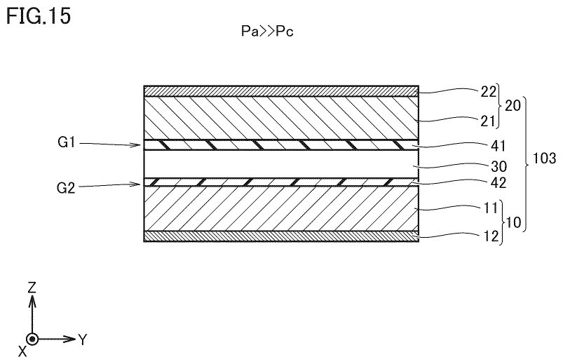

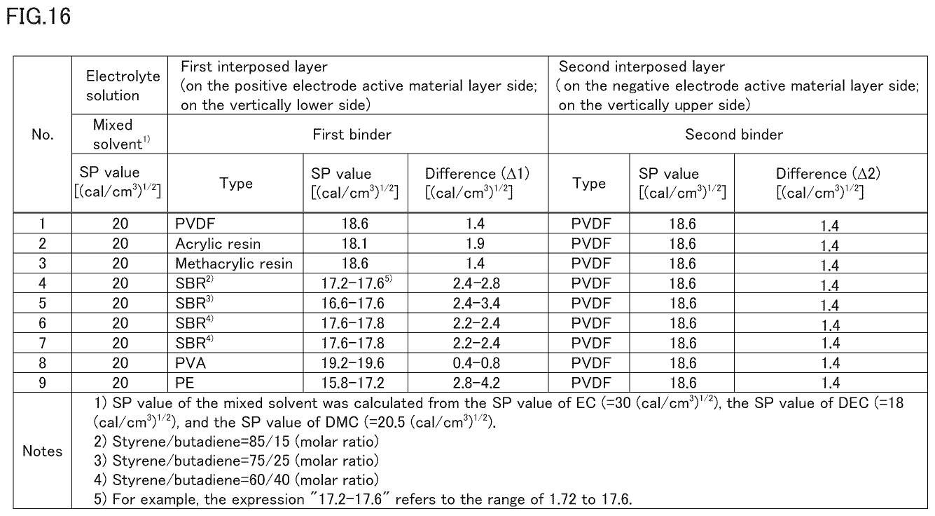

FIG. 15 is a conceptual view illustrating the configuration of an evaluation cell. FIG. 16 is a table showing the configuration of an interposed layer of an evaluation cell. Evaluation cells 103 of No. 1 to No. 9 were prepared. Evaluation cell 103 includes positive electrode 10, first interposed layer 41, separator 30, second interposed layer 42, and negative electrode 20 in this order. First interposed layer 41 and second interposed layer 42 include inorganic particles and a binder. The details of the binder in each evaluation cell are specified in FIG. 16. Other materials are the same between different evaluation cells. The inorganic particles in the interposed layer are alumina. The electrolyte solution includes a mixed solvent. The mixed solvent includes EC, DEC, and DMC. Positive electrode active material layer 12 includes NCM. Negative electrode active material layer 22 includes graphite. In evaluation cell 103, the coefficient of permeability through positive electrode active material layer 12, (Pc), and the coefficient of permeability through negative electrode active material layer 22, (Pa), satisfy the relationship of “Pa>>Pc”.

### <High-Rate Resistance Test>

3000 cycles of “Charging→Rest→Discharging” were carried out under the conditions described below. “C” is a symbol denoting the hour rate of current. With a current of 1 C, the rated capacity of evaluation cell 103 is discharged in 1 hour.
Charging: 30 C, 10 seconds
Rest: 5 seconds
Discharging: 4 C, 75 seconds

### <Results>

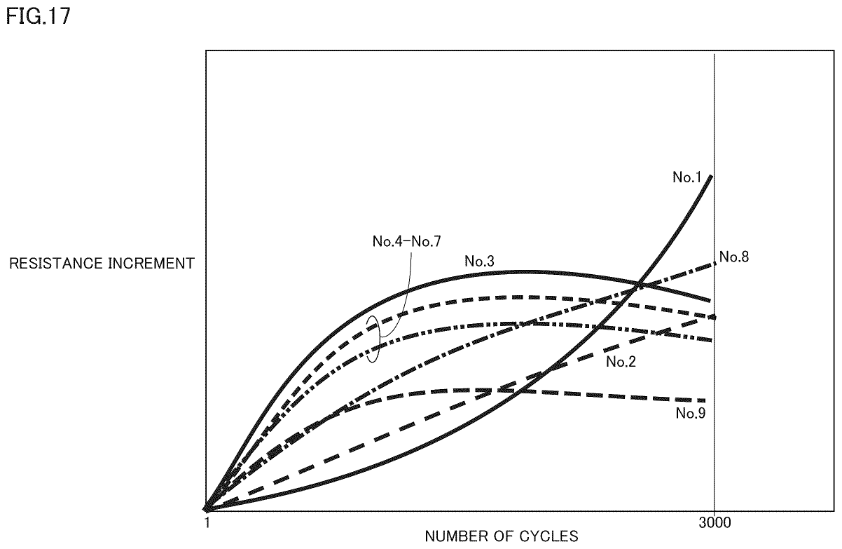

FIG. 17 is a graph showing evaluation results. The slower the increase of resistance increment along an increase of the number of cycles is, the better the high-rate resistance is conceivable to be.

In No. 1, the configuration of the first interposed layer is the same as that of the second interposed layer. It is conceivable that the coefficient of permeability through the first interposed layer, (P1), is equal to the coefficient of permeability through the second interposed layer, (P2). In other words, it is conceivable that the relationship of “P1=P2” is satisfied. In No. 1, the increase of resistance increment along an increase of the number of cycles is noticeable.

In No. 2 to No. 9, the configuration of the first interposed layer is different from that of the second interposed layer. It is conceivable that the coefficient of permeability through the first interposed layer, (P1), is different from the coefficient of permeability through the second interposed layer, (P2). In other words, it is conceivable that the relationship of “P1≈P2” is satisfied. In No. 2 to No. 9, the greater the Δ1 in FIG. 16 is relative to the Δ2, the more improved the high-rate resistance tends to be.

What is claimed is:

1. A lithium-ion battery comprising:
a power generation element; and
an electrolyte solution, wherein
the power generation element includes a positive electrode, a separator, a negative electrode, a first interposed layer, and a second interposed layer,
the positive electrode and the negative electrode are alternately stacked with the separator interposed therebetween,
the positive electrode includes a positive electrode current-collecting foil and a positive electrode active material layer,
the negative electrode includes a negative electrode current-collecting foil and a negative electrode active material layer,
at least one of a first gap and a second gap is formed in the power generation element,
the first gap is a gap formed between the negative electrode active material layer and the separator,
the second gap is a gap formed between the positive electrode active material layer and the separator,
the first interposed layer is placed at at least one of the first gap and the second gap,
the second interposed layer is placed at at least one of the first gap and the second gap,
the power generation element has a stacking direction,
the stacking direction is parallel to a thickness direction of the positive electrode, the separator, and the negative electrode,
the power generation element has a first end portion at one end in the stacking direction and also has a second end portion at the other end in the stacking direction,
the first interposed layer is closer to the first end portion than the second interposed layer is, and
a relationship of an expression (1) below is satisfied,
P1≠P2 (1)
where
P1 represents a coefficient of permeability of the electrolyte solution through the first interposed layer, and
P2 represents a coefficient of permeability of the electrolyte solution through the second interposed layer.

2. The lithium-ion battery according to claim 1, wherein the electrolyte solution is distributed more at the first end portion than at the second end portion.

3. The lithium-ion battery according to claim 1, wherein
the first interposed layer is placed at the second gap, and
the second interposed layer is placed at the first gap.

4. The lithium-ion battery according to claim 1, wherein a relationship of an expression (2) below is satisfied:
P1>P2 (2).

5. The lithium-ion battery according to claim 1, wherein
the electrolyte solution includes a supporting salt and a solvent,
the first interposed layer includes first inorganic particles and a first binder,
the second interposed layer includes second inorganic particles and a second binder, and
a relationship of an expression (3) below is satisfied:
Δ1>Δ2 (3)
where
Δ1 represents an absolute value of a difference between an SP value of the solvent and an SP value of the first binder,
Δ2 represents an absolute value of a difference between an SP value of the solvent and an SP value of the second binder, and
a unit of the SP value is (cal/cm³)^{1/2}.

6. The lithium-ion battery according to claim 5, wherein relationships of an expression (4) and an expression (5) below are satisfied:
2.5≤Δ1 (4)
Δ2≤2 (5).

7. The lithium-ion battery according to claim 2, wherein
the power generation element includes a first unit and a second unit,
in the stacking direction, the first unit is closer to the first end portion than the second unit is,
each of the first unit and the second unit includes the positive electrode, the separator, and the negative electrode,
the first unit includes the first interposed layer at at least one of the first gap and the second gap,
the second unit includes the second interposed layer at at least one of the first gap and the second gap, and
a relationship of an expression (2) below is satisfied:
P1>P2 (2).

8. The lithium-ion battery according to claim 7, wherein the second unit includes the second interposed layer at the second gap.
